(19) United States
(12) Patent Application Publication
(10) Pub. No.: US 2014/0344816 A1
(43) Pub. Date: Nov. 20, 2014

(54) SYSTEM AND METHOD FOR RUNNING PHP INSTANCES

(71) Applicants: Dennis Nadeau, Pompano Beach, FL (US); Greg Hannis, Ft. Lauderdale, FL (US); Virginia Balabanova, Deerfield Beach, FL (US)

(72) Inventors: Dennis Nadeau, Pompano Beach, FL (US); Greg Hannis, Ft. Lauderdale, FL (US); Virginia Balabanova, Deerfield Beach, FL (US)

(21) Appl. No.: 13/893,837

(22) Filed: May 14, 2013

(51) Int. Cl. G06F 9/48

(52) U.S. Cl. CPC G06F 9/48
USPC 718/102

(57) ABSTRACT

The present invention is a method of operating a series of software-based processes having the steps of creating a first PHP based parent instance, forming a multi-thread second PHP instance from the first instance, closing the first instance, and operating an application on the second instance.

### BACKGROUND OF THE INVENTION

One main problem of PHP multithreading engine implementation is a shared piece of memory that, usually vary from one OS to another. This shared memory used by threads in order to talk to each other, get tasks and commands, give back results and use other shared Input/Output, resources if needed. PHP could be used on at least two platforms (Linux, Windows or even, more which have different memory management, structure, etc. from the Programmers point of view. This fact lowers the chances to make a multiplatform PHP multithreading engine.

Several quite strong attempts in the direction of PHP Multithreading are:
1. PHP Threader—Multithreading-like Functionality in PHP.
2. Emulate threads using separate HTTP requests.
3. Improved Thread Simulation Class for PHP

At the first glance the first one, PHP Threader appears to be complete and fine, but in closer look (analysis of code and examples) there are some serious drawbacks exist, namely:

1. There is no distribution of work and a single job would not divide between threads. Work is done by executing in parallel PHP files (threads) that make separate jobs. However multithreading considers single or several jobs equally divided between threads and are being calculated by several threads concurrently.

2. Shared memory is actually a shared file or MySQL database just for sending messages between main thread and other threads, not for distribution of job/tasks and tracing the state etc.

3. There is no proper management of threads Lifecycle.

4. It seems that huge workload could, make problems for calculation and shared, data using such approach.

5. The approach does not provide low-level multithreading. Due to lack of automatic management of job distribution, it is both hard and increases probability of bugs to implement applications that use more than 2-3 threads at once using this package.

What about the second one [13]? The Author alarms “This package provides an alternative solution that consists in sending multiple HTTP requests to the same Web server on which PHP is running”. The third, one [14] is also based on HTTP requests. The approach is reasonable, but both solutions lack of thread management, job distribution etc. They do the first part (start several threads and get response from them) very well, but shared piece of memory, full thread control, distribution of jobs/tasks, etc. is missing. It is also questionable would they work with huge amounts of data.

Other attempts mostly provide information about using, for example, forking in Linux or curling in Windows etc. They still do not provide full Multithreading solution. Additionally there have been numerous attempts with varying degrees of efficacy to realize PHP Multithreading.

The current state of the art leads to more questions then answers such as:

How would we track life-cycle of threads?

What happens if some of the threads would hang on or crash unexpectedly without any notice?

It is recognized that there is a need for a method by which a working PHP Multithreading engine mostly for Information Extraction from Web purposes.

The present method will make running PHP instances more automated, universal, clean and less complicated.

### SUMMARY OF THE INVENTION

In one embodiment, the present invention is a method of operating a series of software-based processes said method comprising the steps of:

creating a first PHP based parent instance on a non-transitory computer readable storage medium;

forming a multi-thread second PHP instance from the first instance on said medium;

closing the first instance;

operating an application on the second instance.

The operating includes using a computer processor

The method provides that the second instance is initially operatively associated with the first instance.

The second instance is initially operatively associated with the first instance and the second instance continues to operate after the closing of the first instance.

When using the second instance, the method provides a reduction in download time to about 1-5% when compared to download time under the same processor and connection speed using linear download and resizing protocol.

The method is carried out on a multiplatform or platform independent system.

In one embodiment, a gaming environment is accessed and used in said second instance.

### BRIEF DESCRIPTION OF THE SEVERAL VIEWS OF THE DRAWINGS

FIG. 1 is a flow chart of the method of the present invention showing parent-child interaction.

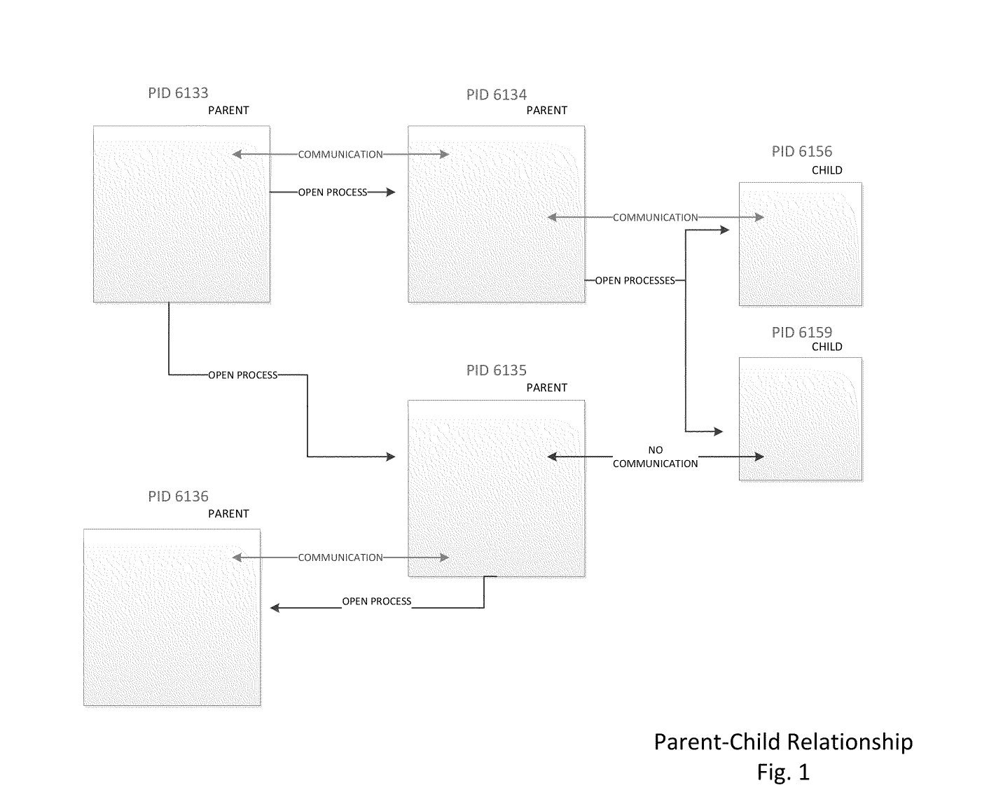

FIG. 2 is a flow chart of the method of the present invention showing the looping process manager.

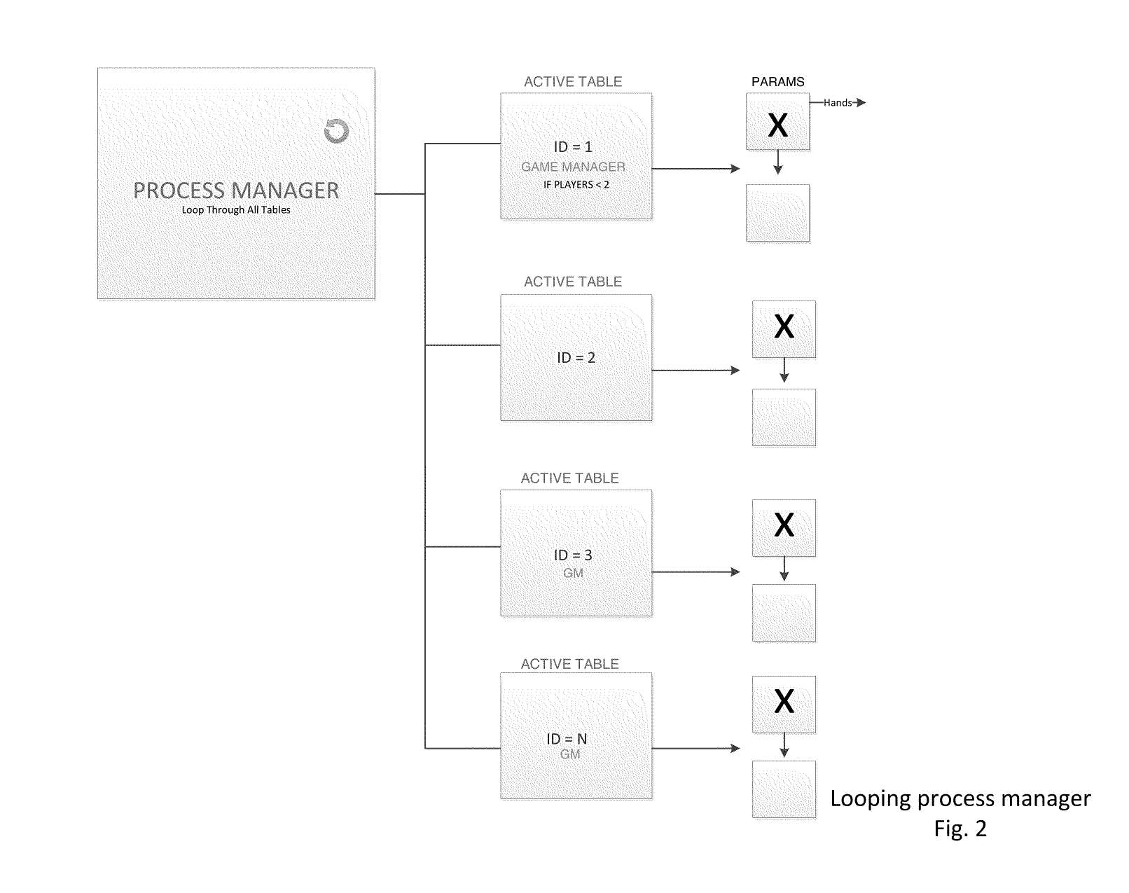

FIG. 3 is a flow chart of the method of the present invention showing process redistribution.

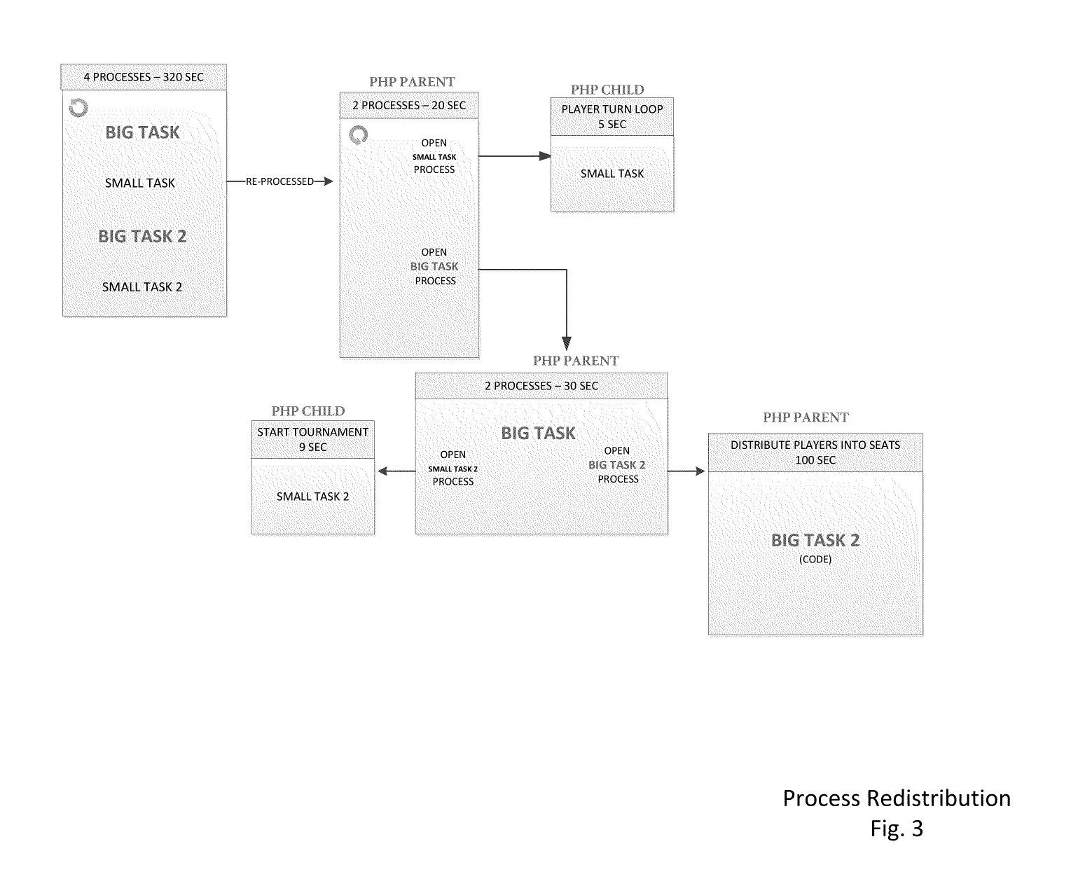

### DETAILED DESCRIPTION OF THE PREFERRED EMBODIMENT

In a preferred embodiment, the present invention encompasses a method of operating a series of software-based processes said method comprising the steps of:

Creating a first PHP based parent Process;
forming a Parallel PHP Process from the first Process; closing the first Process;
leaving second Process to continue to run in own memory space.

In one embodiment the instance of the preset invention is a server side instance. The present invention has provided a novel arrangement whereby the first instance can be terminated and the second instance continues to run. As currently understood in the art, PHP instances terminate when the original first instance is closed. However, the present invention has provided a system whereby any second or subsequent instance continues to operate even when the first instance is closed.

In the preferred embodiment the multi-layered second PHP instance is an application whereby it is desirable to run this application in the absence of the first PHP parent instance existing. The second multi-layer PHP instance can be, by way of example only, any one of an operating system, a program or a game server, although it would not be limited to any of these types of applications.

In a preferred embodiment, the multi-layered second PHP instance is a game server. Until now, programmers have found it unworkable to use the second multi-layered PHP instance as a game server when the first PHP based parent instance is no longer running. The present invention has addressed and solved this problem. As understood by persons with skill in the art, code continues to run through varying processes. In previous attempts to use PHP instances, the initial first parent and second multi-thread PHP instance will continue to run through a large plurality of commands and tasks. This ultimately slows down the completion of the command processes. The present invention, in being constructed and arranged to close the first PHP based parent instance removes a significant amount of executable code and allows code associated with the multi-thread second PHP instances to be the only executable and running code in a system according to the present invention.

In one embodiment, the system is configured such that a significant amount of processes can be interrupted. For example, if we have an instance running processes 1-5 and it is desired to run processes 1-16, however processes 6-15 need to be executed before getting to process 16, the system is formed such that a child instance is created. Said child instance runs processes 6-15, continues with process 16 and any desired subsequent processes, when processes 6-15 are completed it returns the data to the parent process and continues with any desired subsequent processes. What this in fact does is it interrupts the parent so that parent code is continually running. The parent code stops at process 5, generates a child instance, runs processes 6-15. Once processes 6-15 are complete, returns the information to the parent.

In one embodiment, the method of the present invention is utilized in the structure of an on-line poker server. The second multi-layered PHP instance relates to the oversight of the overall table play. The child creation as discussed above, relates to over site of individual tables on the platform. In this particular configuration, the poker program does not need to go through analysis of all tables running on the server. The child process whereby particular executable steps are maintained is individualized for one or more specific tables. In this type of configuration, again, it does not need to execute the entirety of the code in order to manage an individual table. This configuration creates an advantageous efficiency whereby the time to monitor and make system correction or a change to individual table requires a greatly reduced and reduced amount of executed code.

### Shared Memory

The present invention incorporates shared memory. As a snared piece of memory any database (MySql, Postgres, Oracle, etc.) could be used

We need only two tables (please see a picture below), one for messaging/tasking/command called cmd and another one for tracking the life-cycle of threads called threads, as demonstrated in the table below.

TABLE 1
cms and thread tables

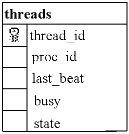

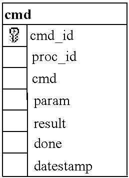

Table 1: Cmd
cmd_id - just a primary key
proc_id - ID of a thread
cmd - command given (for example: calculate, exit, etc.)
param - additional parameters needed for the command, usually a serialized PHP object
result - stored after the command was done, usually a serialized PHP object.
done - flag for Main thread, was command/task done or not, helps to calculate results and reassign task to another thread if current is not responding.
datestamp - just and time and date
Table: Threads
threads_id - just a primary key
proc_id - ID of a thread
last _beat - last timestamp when Thread was alive
busy - flag, is it busy or not
state - parameter that represents state (for example exit, ready, etc.)

Tables and commands are ANSI SQL compatible, that means there is no problem using other databases like MySQL, Postgres, Oracle etc. In one embodiment, the EZsql DB abstraction class is used, so it is easy to change the DB engine. EZsql is not the only solution/abstraction class and one can utilize a custom selected, connector to access the Database).

TABLE 2
MSSQL DDL of cmd and thread tables:

CREATE TABLE [threads] (
[threads_id] [bigint] IDENTITY (1, 1) NOT NULL ,
[proc_id] [int] NULL ,
[last_beat] [varchar] (50) NULL ,
[busy] [int] NULL ,
[state] [int] NULL
) ON [PRIMARY]
CREATE TABLE [cmd] (
[cmd_id] [bigint] IDENTITY (1, 1) NOT NULL ,
[proc_id] [int] NULL ,
[cmd] [varchar] (255) NULL ,
[param] [text] NULL ,
[result] [text] NULL ,
[done] [int] NULL ,
[datestamp] [datetime] NULL
) ON [PRIMARY] TEXTIMAGE_ON [PRIMARY]

### Example of Data

Data shown is for application with 30 threads. Cmd table. Threads table.

### Improvement II: Message Broker

Message/task/commands brokering is done through Database together with the functions in the code:

Loop “THREADS main cycle”

do{
...
}while($q);
and
function tell($thought, $params = NULL) {...}
and finally
### Get results block

### Improvement III: Thread Life-Cycle Management

The present invention identifies which of the threads are ready for processing, which are busy, which are ended the processing and asking for termination, etc. Message broker is used to give “vital” commands to threads. This is a job of the following functions:

function isActive ( ) { }
function isBusy( ) { }

### Performance and Evaluation: 5 Hours vs 3 Minutes

One of the applications where the code was used was a massive download and generating thumbnails from, pictures.

Work volume: ˜3000 JPEG pictures, 0.5-1.5 Mb each
Hardware used: 1.4 Ghz Pentium 4 processor, 2 GE RAM, IIS 5.5 etc.
Internet connection: 8/8 Mbit synchronous connection Linear download, and resizing would take 5 hours Multithreaded solution with 20 threads took less than 3 minutes.

### What Definitely Distinguishes PHP Multithreading Engine Proposed in Current Article?

1. Multiplatform or platform independent

2. Highly customizable and lightweight

3. There is no redundant code inside; only best in this case technologies are used.

4. Works both in the Web and as CLI

5. Code is OOP, well commented, easy to understand, do not depend on any other frameworks or drivers.

6. As a thread shared memory any Database Engine could be used (MySQL, Postgres, Oracle, MSSQL etc.). It provides the ability to use full power of RDBMS.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A method of operating a series of software-based processes said method comprising the steps of:
creating a first PHP based parent instance on a non-transitory computer readable storage medium;
forming a multi-thread second PHP instance from the first instance;
closing the first instance;
operating an application on the second instance.

2. The method of claim 1 wherein said second instance is initially operatively associated with the first instance.

3. The method of claim 1 wherein said second instance is initially operatively associated with the first instance and said second instance continues to operate after the closing of the first instance.

4. The method of claim 1 wherein the operation of an application on said second instance includes a reduction in download time to about 1-5% when compared to download time under the same processor and connection speed using

5. The method of claim 1 wherein the method is carried out on a multiplatform or platform independent system.

6. The method of claim 1 wherein a gaming environment is accessed and used in said second instance.
